(19) United States
(12) Patent Application Publication
(10) Pub. No.: US 2012/0008108 A1
(43) Pub. Date: Jan. 12, 2012

(54) PROJECTION DISPLAY DEVICE

(75) Inventors: Taichi Yoshimura, Osaka-city (JP); Seiji Yamamoto, Osaka-City (JP)

(73) Assignee: SANYO ELECTRIC CO., LTD., Moriguchi city (JP)

(21) Appl. No.: 13/180,789

(22) Filed: Jul. 12, 2011

(30) Foreign Application Priority Data
Jul. 12, 2010 (JP) 2010-157736

(51) Int. Cl. G03B 21/20

(52) U.S. Cl. 353/87

(57) ABSTRACT

A projection display device includes: a light source; a rod-type integrator which unifies light emitted from the light source in intensity distribution; an imager which modulates the light emitted from the integrator; and an optical axis adjuster for adjusting an optical axis of the light source with respect to an incidence plane of the integrator. In this arrangement, the integrator has the incidence plane formed in the shape of a rectangle and inclines around an optical axis of the integrator with respect to an installation surface of a main body cabinet in which the light source is disposed. In addition, the optical axis adjuster shifts the light source relatively with respect to the incidence plane in a direction parallel to a shorter side of the incidence plane.

This application claims priority under 35 U.S.C. Section 119 of Japanese Patent Application No. 2010-157736 filed Jul. 12, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for modulating light flux emitted from a light source by an imager, and enlarging and projecting the modulated light onto a projection plane.

2. Disclosure of Related Art

Conventionally, a projection display device (hereinafter, called “projector”) such as a liquid crystal projector is configured such that light flux emitted from a light source is modulated by an imager and projected by a projection lens onto a projection plane. Hereinafter, “light flux” will be referred to simply as “light” except for the cases where the term “light flux” is more desirable.

In such a projector, it is necessary to unify illuminance distribution of light radiated to the imager. Accordingly, a rod-type integrator (hereinafter, called “rod integrator”) is disposed between the light source and the imager, for example. The rod integrator includes a light tunnel and a glass rod integrator, for example. The light tunnel has a hollow interior and a mirror plane on an inner surface. The glass rod integrator has a solid interior and is made of a glass material.

The imager has a modulation plane (display plane) formed in the shape of a rectangle adapted to a shape of a screen onto which an image is projected. In addition, the rod integrator also has incidence and output planes formed in the shape of a rectangle adapted to the shape of the modulation plane.

Light unified in intensity distribution by the rod integrator is guided to the imager by a relay optical system composed of a relay lens and a mirror. The rod integrator is disposed such that the light is properly radiated to the imager. Accordingly, depending on layout of the relay optical system, the rod integrator may be inclined around an optical axis of the rod integrator with respect to an installation surface of the main body cabinet in which the light source and the imager are disposed.

Meanwhile, the light emitted from the light source is collected by a reflector and a lens, and then is entered into the rod integrator. At that time, if a center of the light flux radiated to the incidence plane of the rod integrator is displaced from a center of the incidence plane, the light cannot be properly unified in intensity distribution, which may result in occurrence of uneven illuminance on the imager. In addition, if part of the light flux emitted from the light source extends off the incidence plane, a decreased amount of light is taken into the rod integrator, which may reduce illuminance on the imager.

Accordingly, such a projector may be provided with an optical axis adjustment portion for adjusting an optical axis of the light source with respect to the incidence plane of the rod integrator. For example, the optical axis adjustment portion may be configured to shift the light source in biaxial directions vertical to the optical axis of the light source.

In this configuration, even if the center of the light flux is displaced in any one of the biaxial directions, it is possible to align the center of the light flux with the center of the incidence plane to the extent that the light source can be shifted.

However, if the optical axis of the light source is made adjustable in the biaxial directions as described above, the optical axis adjustment portion is prone to be complicated in structure, which requires an increased number of adjustment tasks due to the need for adjustment in the two directions.

Meanwhile, if the optical axis adjustment portion is configured such that the light source can be shifted only in a uniaxial direction vertical to the optical axis of the light source, the optical axis adjustment portion becomes simplified in structure, thereby reducing adjustment tasks.

However, this configuration presents an issue of how to configure the optical axis adjustment portion with respect to the rod integrator which has the rectangular incidence plane and inclines with respect to the installation surface of the main body cabinet as described above, in such a manner that the center of the light flux can be approached to the center of the incidence plane and that the light flux can be prevented from extending off the incidence plane, by shifting the light source only in the uniaxial direction.

### SUMMARY OF THE INVENTION

A projection display device according to a main aspect of the present invention includes: a light source; a rod-type integrator which unifies light emitted from the light source in intensity distribution; an imager which modulates the light emitted from the integrator; and an optical axis adjuster for adjusting an optical axis of the light source with respect to an incidence plane of the integrator. In this arrangement, the integrator has the incidence plane formed in the shape of a rectangle and inclines around an optical axis of the integrator with respect to an installation surface of a main body cabinet in which the light source is disposed. In addition, the optical axis adjuster shifts the light source relatively with respect to the incidence plane in a direction parallel to a shorter side of the incidence plane.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector in the embodiment.

FIG. 3 is a diagram showing an internal structure of the projector in the embodiment.

FIG. 4 is a diagram schematically showing a configuration of an imager unit in the embodiment.

FIG. 5 is a diagram schematically showing a configuration of a projection optical unit in the embodiment.

FIGS. 6A and 6B are diagrams showing a configuration of a lamp unit in the embodiment.

FIGS. 7A and 7B are diagrams showing configurations of a first holder and a second holder in the embodiment.

FIGS. 8A and 8B are front views of the lamp unit disposed within a main body cabinet in the embodiment.

FIGS. 9A and 9B are diagrams showing movements of light flux on an incidence plane of a light tunnel at adjustment of an optical axis of a light source lamp in the embodiment.

FIGS. 10A and 10B are diagrams showing movements of light flux on the incidence plane of the light tunnel at adjustment of the optical axis of the light source lamp in the case where a center of the light flux is displaced in a direction that cannot be adjusted in the embodiment.

The drawings are provided only for describing the present invention, and do not limit the scope of the present invention.

### DESCRIPTION OF PREFERRED EMBODIMENTS

An embodiment of the present invention will be described below referring to the drawings.

In this embodiment, a lamp opening 1c corresponds to an “opening” recited in the claims. A lamp cover 5 corresponds to a “cover” recited in the claims. A light tunnel 152 corresponds to an “integrator” recited in the claims. A DMD 154 corresponds to an “imager” recited in the claims. A light source lamp 300 corresponds to a “light source” recited in the claims. An axial portion 415 corresponds to a “guided portion” recited in the claims. A guide hole 424 corresponds to a “guiding portion” recited in the claims. An arm portion 416 corresponds to an “operation portion” recited in the claims. The first holder 401, the second holder 402, the axial portion 415, and the guide hole 424 constitute an “optical axis adjustment portion” recited in the claims. These correspondences in description between the claims and the embodiment are merely examples, and do not limit the claims to this embodiment.

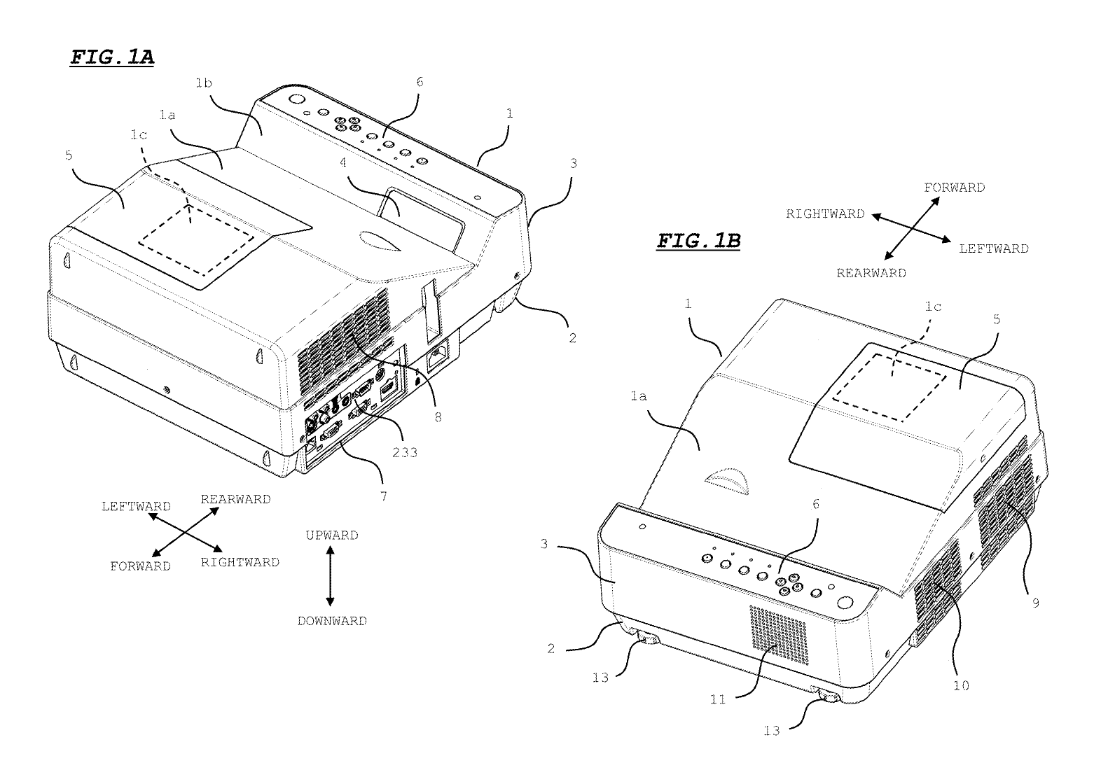

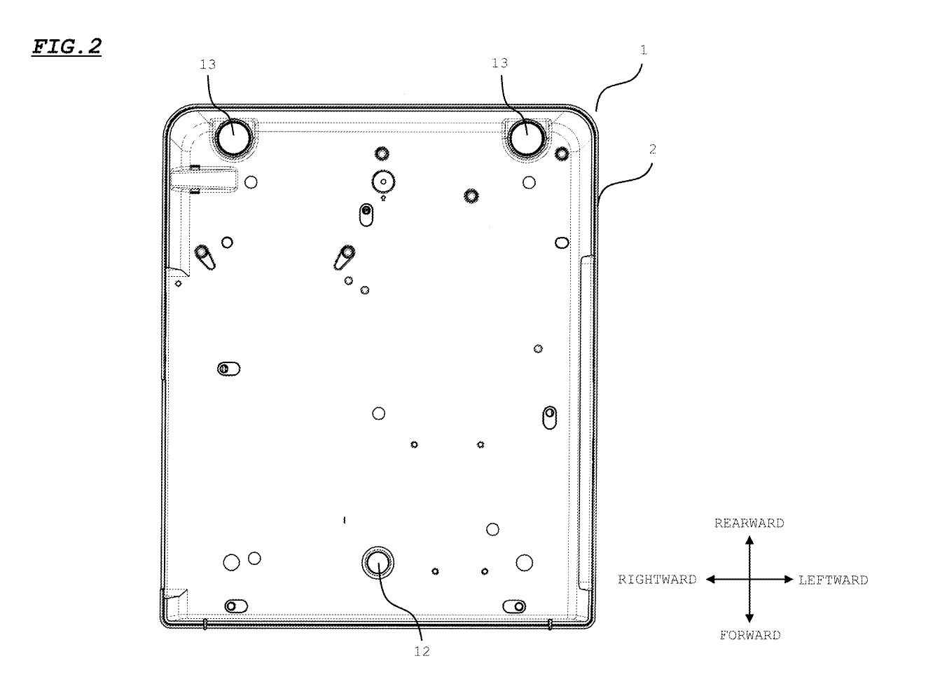

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions, and arrows each indicating upward and downward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening 1c for use in exchanging a lamp unit, and a filter opening (not shown) for use in exchanging a filter disposed in a fan unit for cooling the lamp unit. The lamp cover 5 is a cover for covering the lamp opening 1c and the filter opening. Further, the top surface of the main body cabinet 1 is provided with an operation key portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 is formed in a front portion on a left surface of the main body cabinet 1, and a second air outlet 10 is formed in a middle portion on the left surface of the main body cabinet 1. Each of the first and second air outlets 9, 10 is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

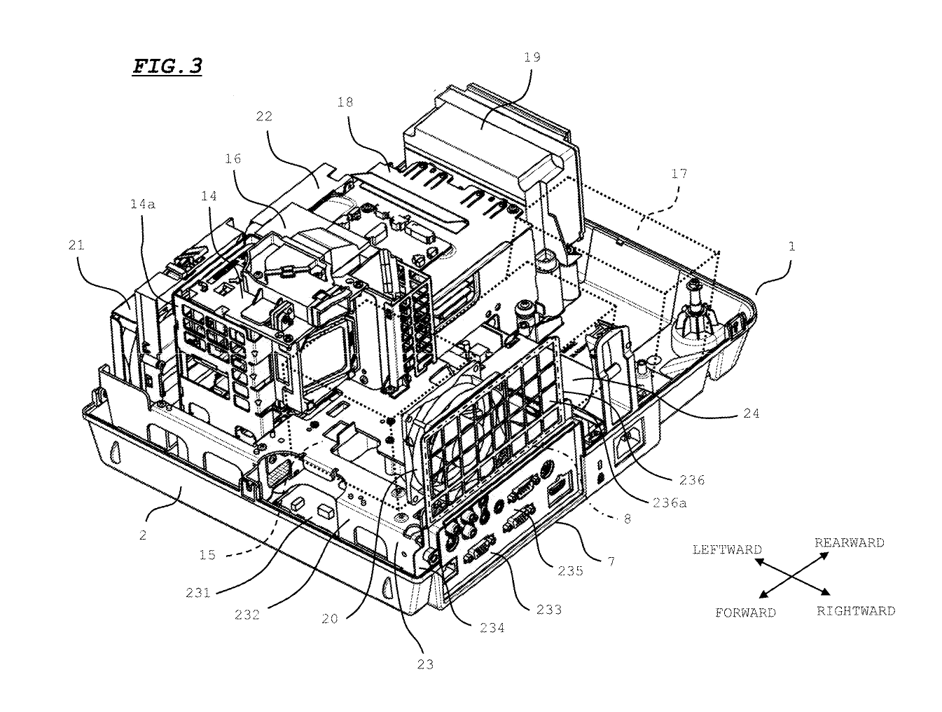

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted by a light source lamp and a lamp holder holding the light source lamp. The lamp unit 14 is held within a lamp frame 14a so as to be capable of being attached and detached from above.

A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

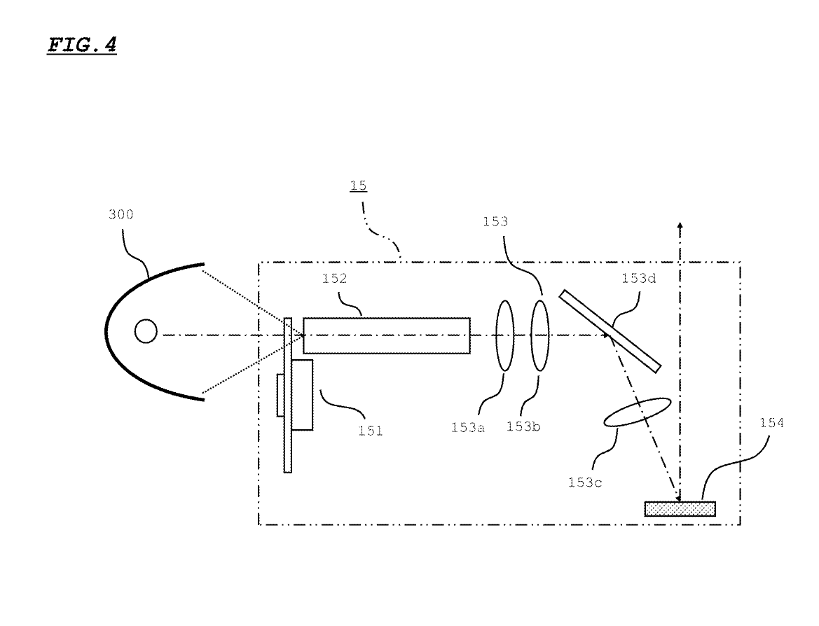

FIG. 4 is a diagram schematically showing a configuration of the imager unit 15.

The imager unit 15 includes a color wheel 151, a light tunnel 152, a relay optical system 153, and a digital micro-mirror device (DMD) 154.

The color wheel 151 splits white light from the light source lamp 300 into light of colors such as red, green, and blue in a time-sharing manner. The light tunnel 152 has a hollow interior and a mirror plane on an inner surface. The light tunnel 152 has incidence and output planes formed in the shape of a rectangle. Light entered into the light tunnel 152 is unified in intensity distribution through repeated reflections while passing through the light tunnel 152.

The relay optical system 153 is constituted by three relay lenses 153a, 153b, and 153c and a mirror 153d, to guide the light emitted from the light tunnel 152 to the DMD 154. The DMD 154 modulates the light guided by the relay optical system 153 (light of red, green, blue, and others) in accordance with image signals. The DMD 154 has a modulation plane formed in the shape of a rectangle as with the incidence and output planes of the light tunnel 152.

Returning to FIG. 3, the projection optical unit 17 is disposed behind the imager unit 15. The projection optical unit 17 enlarges image light generated by the imager unit 15 and projects the same onto a projection plane such as a screen.

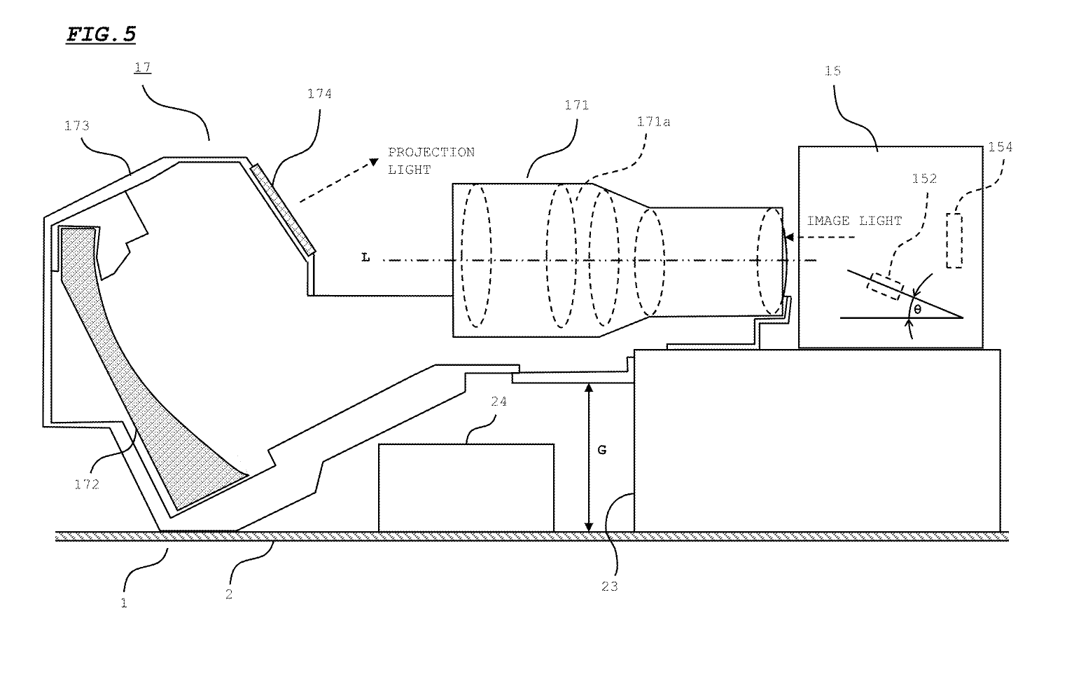

FIG. 5 is a diagram schematically showing an arrangement of the projection optical unit 17. In FIG. 5, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 5, image light emitted from the imager unit 15 is entered into the projection lens unit 171 at a position shifted from the optical axis L of the projection lens unit 171 in a direction toward the top surface of the main body cabinet 1. The entered image light is provided with a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

As shown in FIG. 5, the DMD 154 is disposed such that a bottom surface thereof becomes parallel to the bottom surface of the main body cabinet 1 (lower cabinet 2). Meanwhile, the light tunnel 152 is inclined at an angle of θ around an optical axis of the light tunnel 152 with respect to the bottom surface of the main body cabinet 1, so that the light guided by the relay optical system 153 can be properly radiated to the modulation plane of the DMD 154. In addition, the light tunnel 152 disposed such that a longer side of the incidence plane is vertically oriented.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager unit 15. The DMD cooling fan 20 supplies outside air taken in from the air inlet 8 to the imager unit 15 to thereby cool down the DMD 154. The DMD 154 is disposed hermetically within the imager unit 15, and therefore the DMD 154 does not contact directly the supplied outside air.

A first exhaust unit 21 is disposed on the left of the lamp unit 14. The first exhaust unit 21 discharges air that has cooled the light source lamp 300 to the outside through the first air outlet 9. The first exhaust unit 21 also discharges air that has cooled the DMD to the outside through the first air outlet 9.

A second exhaust unit 22 is disposed on the left of the power source unit 18. The second exhaust unit 22 discharges air that has been warmed in the inside of the power source unit 18 to the outside through the second air outlet 10. By flowing air from the inside of the power source unit 18 to the second exhaust unit 22, fresh external air is supplied into the power source unit 18 through the air inlet 8.

As shown in FIG. 3 and FIG. 5, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

The control circuit board 231 has a control circuit for controlling various drive parts such as the light source lamp 300 and the DMD 154. In addition, the control circuit board 231 has various terminals 235.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

Next, a configuration of the lamp unit 14 will be described in detail.

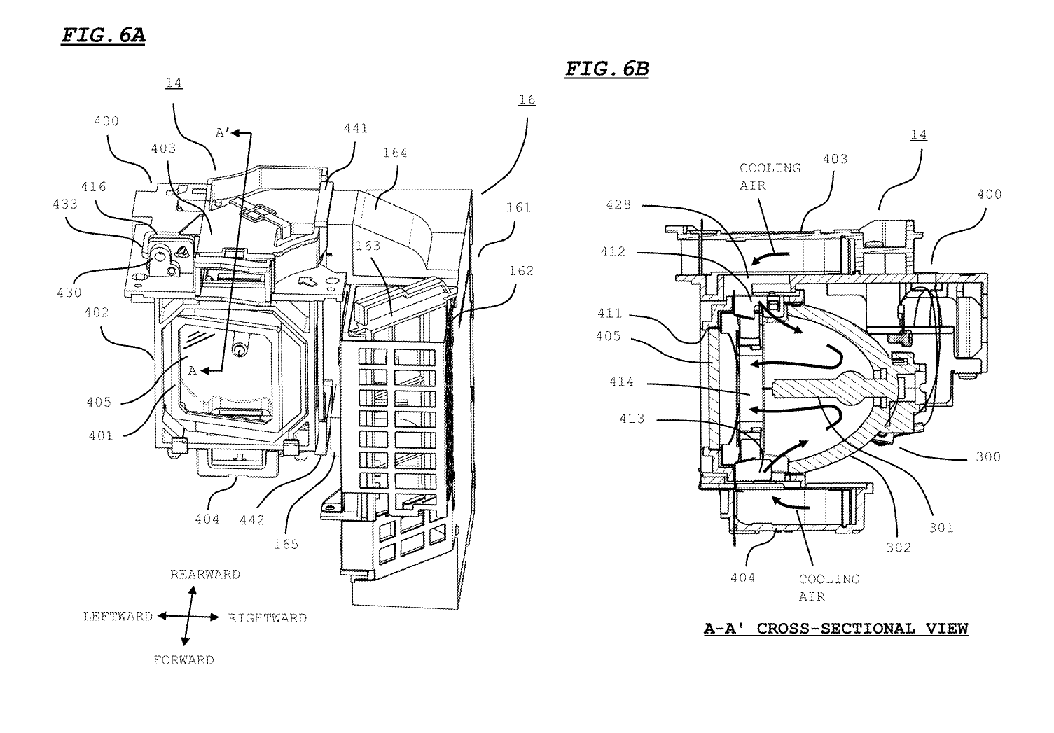

FIGS. 6A and 65 are diagrams showing the configuration of the lamp unit 14. FIG. 6A is a front perspective view of the lamp unit 14, and FIG. 6B is a cross-sectional view of FIG. 6A taken along a line A-A′. In addition, FIG. 6A depicts a fan unit 16 as well as the lamp unit 14.

Referring to FIGS. 6A and 6B, the lamp unit 14 is constituted by the light source lamp 300 and a lamp holder 400 for holding the light source lamp 300.

The light source lamp 300 includes an arc tube 301 and a reflector 302 (see FIG. 65). A metal halide lamp is used as the arc tube 301. Alternatively, an ultra-high pressure mercury lamp, a xenon lamp, or the like are used as the arc tube 301. The reflector 302 has an oval inner surface, and reflects white light emitted from the arc tube 301 on the inner surface so as to travel forward.

The lamp holder 400 includes a first holder 401 holding the light source lamp 300, a second holder 402 holding the first holder 401, and an upper duct 403 and a lower duct 404 two of which are attached to the second holder 402.

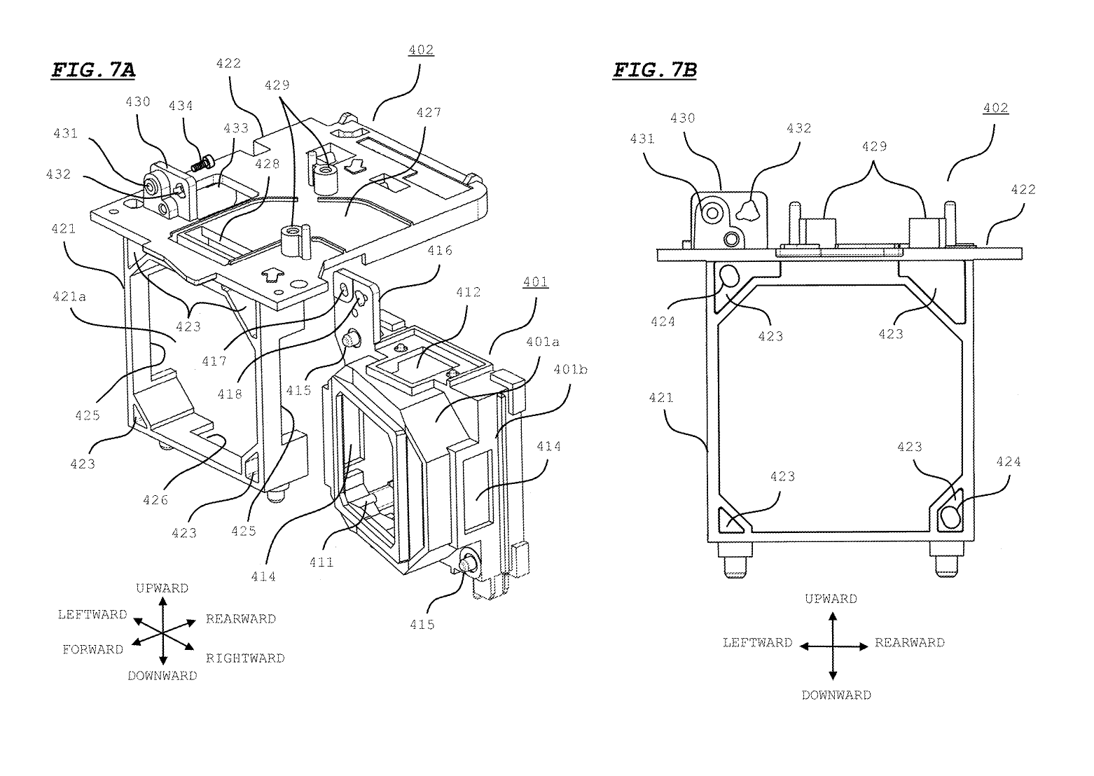

FIGS. 7A and 7B are diagrams showing configurations of the first holder 401 and the second holder 402. FIG. 7A is an exploded perspective view of the first holder 401 and the second holder 402, and FIG. 7B is a front view of the second holder 402.

Referring to FIGS. 7A and 7B, the first holder 401 has a front section 401a in the shape of an approximate octagon as seen from the front, and has a rear section 401b in the shape of an approximate square as seen from the front. The first holder 401 has on a front surface thereof an output window 411 through which light from the light source lamp 300 is emitted. The output window 411 has a heat-resistance glass plate 405 fitted therein as shown in FIGS. 6A and 6B. The first holder 401 has an opening on a rear side thereof to which the light source lamp 300 is attached from behind.

The first holder 401 has an upper blowing port 412 on a top surface thereof. In addition, the first holder 401 has a lower blowing port 413 on a lower surface thereof (see FIG. 6B). Further, the first holder 401 has exhaust ports 414 on right and left side surfaces thereof.

The first holder 401 has cylindrical axial portions 415 projecting forward from upper left and lower right corners on a front surface of the rear section 401b. In addition, the first holder 401 has an arm portion 416 extending upward from an upper left portion of the rear section 401b. The arm portion 416 has a screw insertion hole 417 and a tool insertion hole 418. The screw insertion hole 417 is made longer in a direction in which the first holder 401 is shifted with respect to the second holder 402 at adjustment of the optical axis of the light source lamp 300. At adjustment of the optical axis of the light source lamp 300, an adjustment tool such as a driver is inserted into the tool insertion hole 418.

The second holder 402 is constituted by a frame section 421 and a top plate 422 extending rearward from a top of the frame section 421.

The front section 401a of the first holder 401 is fitted into the frame section 421. The frame section 421 is approximately square in outer shape, and has an inside opening 421a in the shape of an approximate octagon adapted to the shape of the front section 401a. The opening 421a is made slightly larger in size than the front section 401a so that the front section 401a can move within the opening 421a.

The frame section 421 has concave portions 423 at four corners thereof. The concave portions 423 at the upper left and lower right corners have guide holes 424 on bottom surfaces thereof. The guide holes 424 are made longer in the direction in which the first holder 401 is shifted with respect to the second holder 402 at adjustment of the optical axis of the light source lamp 300, as with the screw insertion hole 417.

The frame section 421 has notches 425 at right and left sites thereof to turn aside the right and left exhaust ports 414 of the first holder 401. Similarly, the frame section 421 has a notch 426 at a lower site thereof to turn aside the lower blowing port 413 of the first holder 401.

The top plate 422 has a duct attachment portion 427 to which the upper duct 403 is attached. The duct attachment portion 427 has a guide outlet 428 on a front portion thereof. The upper duct 403 has an open lower part, and thus when the upper duct 403 is attached to the duct attachment portion 427, a flow path for cooling air is formed (see FIGS. 6A and 6B). The upper duct 403 is fixed with screws to the attachment bosses 429 of the top plate 422.

The top plate 422 is provided with a fixing plate 430 at the front left portion thereof. The fixing plate 430 has a nut 431 embedded therein and a screw hole of the nut 431 oriented in forward and rearward direction. In addition, the fixing plate 430 has a tool insertion hole 432. At adjustment of the optical axis of the light source lamp 300, an adjustment tool such as a driver is inserted into the tool insertion hole 432. Further, the top plate 422 has an arm insertion opening 433 at a rear of the fixing plate 430.

When the first holder 401 is attached to the second holder 402, the front section 401a of the first holder 401 is fitted from a rear side into the opening 421a of the second holder 402. At that time, the two axial portions 415 of the first holder 401 are inserted into the guide holes 424 of the second holder 402 corresponding to the axial portions 415. In addition, the arm portion 416 of the first holder 401 passes through the arm insertion opening 433 and overlaps the rear part of the fixing plate 430 on the second holder 402 (see FIG. 6A). Accordingly, the screw insertion hole 417 of the arm portion 416 is aligned with the nut 431 of the fixing plate 430.

The screw 434 is inserted into the screw insertion hole 417 from a rear side of the arm portion 416 and then is fastened at the nut 431. When the screw 434 is completely tightened, the arm portion 416 is strongly sandwiched between a head of the screw 434 and the fixing plate 430. Accordingly, the first holder 401 is fixed to the second holder 402.

When the first holder 401 with the light source lamp 300 is attached to the second holder 402 and the upper duct 403 and the lower duct 404 are attached to the second holder 402, the lamp unit 14 is completed as shown in FIG. 6A.

The lamp unit 14 is supplied with cooling air from the fan unit 16. As shown in FIG. 6A, the fan unit 16 includes a fan casing 161 storing two lamp cooling fans (not shown). The fan casing 161 has a filter storing portion 162 at an air inlet. The filter storing portion 162 stores the filter 163 in a detachable manner.

In addition, the fan casing 161 has an upper supply duct 164 and a lower supply duct 165. The upper supply duct 164 is connected to a guide inlet 441 of the upper duct 403 of the lamp holder 400, and the lower supply duct 165 is connected to a guide inlet 442 of the lower duct 404 of the lamp holder 400.

When the lamp cooling fans are operated, air within the main body cabinet 1 is guided as cooling air into the fan casing 161 via the filter 163. In addition, the cooling air flows into the upper duct 403 and the lower duct 404 through the upper supply duct 164 and the lower supply duct 165.

FIG. 6B shows by arrows flow of the cooling air in the lamp unit 14. The cooling air having entered into the upper duct 403, flows through the duct and passes through the guide outlet 428, and blows into an interior of the reflector 302 of the light source lamp 300 from the upper blowing port 412. The cooling air having entered into the lower duct 404, flows through the duct and blows into the interior of the reflector 302 from the lower blowing port 413. The cooling air flowing into the reflector 302 from the upper and lower sides cools down the interior of the reflector 302. After that, the cooling air within the reflector 302 is discharged from the exhaust ports 414 to the outer side of the lamp unit 14.

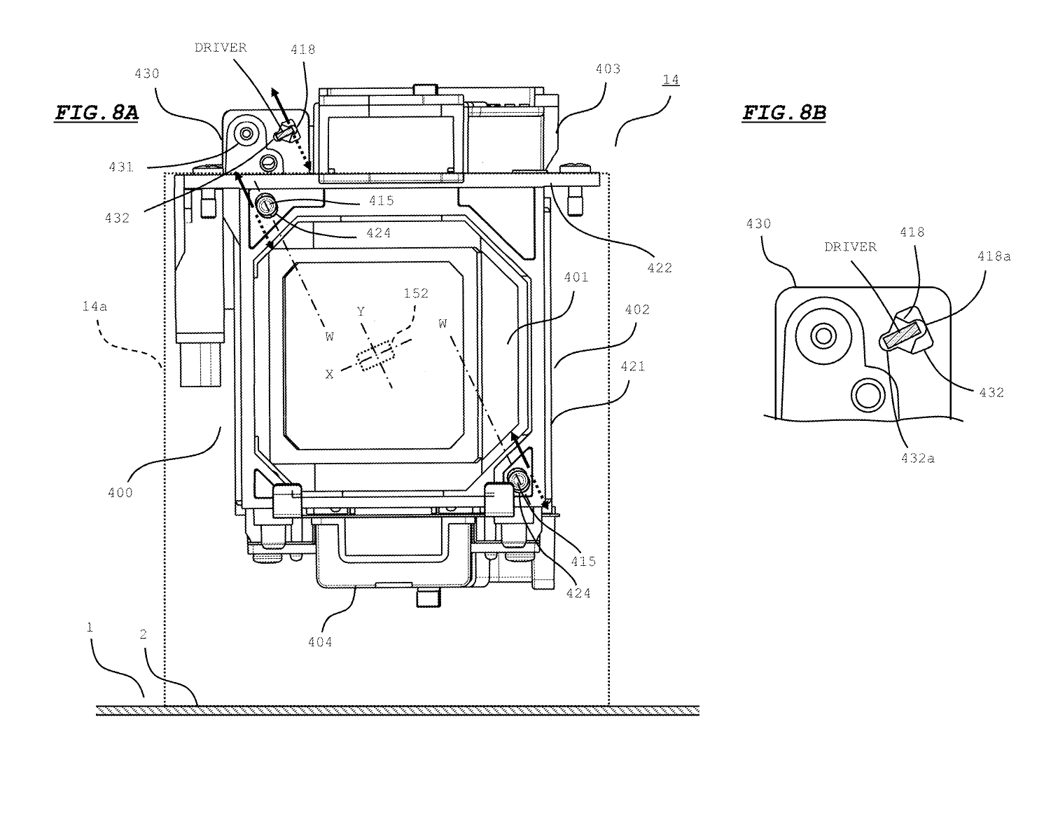

FIG. 8A is a front view of the lamp unit 14 disposed within the main body cabinet 1. FIG. 8B is an enlarged view of the fixing plate 430 shown in FIG. 8A. For the sake of convenience, FIG. 8A depicts by dotted lines the light tunnel 152 positioned on the front of the lamp unit 14 and the lamp frame 14a holding the lamp unit 14.

As shown in FIGS. 8A and 8B, a central axis parallel to a longer side of the incidence plane of the light tunnel 152 is designated as a central axis X, and a central axis parallel to a shorter side of the same is designated as a central axis Y. In addition, a central axis in a longitudinal direction of the guide hole 424 of the second holder 402 is designated as a central axis W.

When the lamp unit 14 is disposed within the main body cabinet 1, the central axis W of the guide hole 424 is parallel to the central axis Y of the light tunnel 152. Accordingly, when the axial portion 415 is guided by the guide hole 424, the first holder 401 is shifted in a direction parallel to a shorter side of the incidence plane of the light tunnel 152.

Next, adjustment of the optical axis of the light source lamp 300 will be described below.

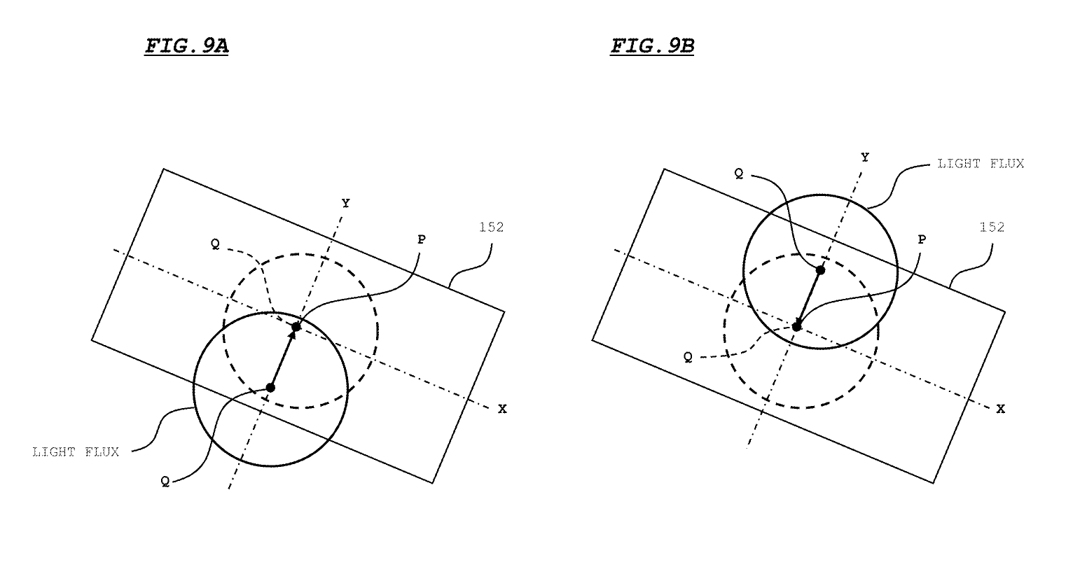

FIGS. 9A and 9B are diagrams showing movements of light flux on the incidence plane of the light tunnel 152 at adjustment of the optical axis of the light source lamp 300. FIG. 9A shows movement of the light flux when a center Q of the light flux is displaced downward from the center P of the incidence plane, and FIG. 9B shows movement of the light flux when the center Q of the light flux is displaced upward from the center P of the incidence plane. FIGS. 9A and 9B each show by a solid line the light flux before the adjustment of the optical axis, and show by a broken line the light flux after the adjustment of the optical axis. In either case of FIGS. 9A and 9B, the center Q of the light flux is not displaced in a direction vertical to the central axis Y (parallel to the central axis X).

As shown in FIGS. 9A and 9B, if the center Q of the light flux is displaced in a direction parallel to the central axis Y, part of the light flux is prone to extend off the incidence plane of the light tunnel 152.

At adjustment of the optical axis of the light source lamp 300, an operator opens the lamp cover 5 of the main body cabinet 1 shown in FIGS. 1A and 1B. Accordingly, the lamp unit 14 shown in FIG. 3 becomes exposed to the outside through the lamp opening 1c. Next, the operator uses a driver to loosen the screw 434 fixing the first holder 401 shown in FIG. 7A. Then, as shown in FIG. 8B, the operator inserts a leading end portion of the driver from a rear side of the lamp unit 14 into the tool insertion holes 418 and 432 overlapping in forward and rearward direction. One end of the leading end portion of the driver engages with an extending portion 418a of the tool insertion hole 418, and the other end of the leading end portion of the driver engages with an extending portion 432a of the tool insertion hole 432.

As shown in FIG. 9A, if the center Q of the light flux is displaced downward from the center P of the incidence plane, the operator moves upward the end portion of the driver on the extending portion 418a side, with the end portion of the driver on the extending portion 432a side as a supporting point. As shown by solid arrows in FIG. 8A, the tool insertion hole 418, that is, the arm portion 416 is pressed upward, and thus the axial portion 415 of the first holder 401 is shifted upward along the guide hole 424 of the second holder 402. Accordingly, the first holder 401, that is, the light source lamp 300 is shifted upward in parallel to the central axis Y of the light tunnel 152. The operator shifts the first holder 401 until the center Q of the light flux coincides with the center P of the incidence plane.

Meanwhile, as shown in FIG. 9B, if the center Q of the light flux is displaced upward from the center P of the incidence plane, the operator moves downward the end portion of the driver on the extending portion 418a side. As shown by broken arrows in FIG. 8A, the arm portion 416 is pressed downward, and the axial portion 415 of the first holder 401 is shifted downward along the guide hole 424 of the second holder 402. Accordingly, the first holder 401, that is, the light source lamp 300 is shifted downward in parallel to the central axis Y of the light tunnel 152. The operator shifts the first holder 401 until the center Q of the light flux coincides with the center P of the incidence plane.

When the center Q of the light flux coincides with the center P of the incidence plane, the operator fully tightens the screw 434 in that state to fix the first holder 401 to the second holder 402. Accordingly, the optical axis of the light source lamp 300 is completely adjusted. This allows the light flux emitted from the light source lap 300 to be entered into the center of the incidence plane of the light tunnel 152 without extending off the incidence plane.

The examples shown in FIGS. 9A and 9B are based on the assumption that the center Q of the light flux is not displaced in a direction parallel to the central axis X, that is, a direction in which the first holder 401 cannot be shifted or adjusted (a direction vertical to the direction parallel to the shorter side of the incidence plane of the light tunnel 152). However, in reality, the center Q of the light flux may be displaced in such a direction that cannot be adjusted. Nevertheless, since the light tunnel 152 is longer in the direction parallel to the central axis X, it is unlikely that part of the light flux extends off the incidence plane of the light tunnel 152, even though the center Q of the light flux is displaced in this direction.

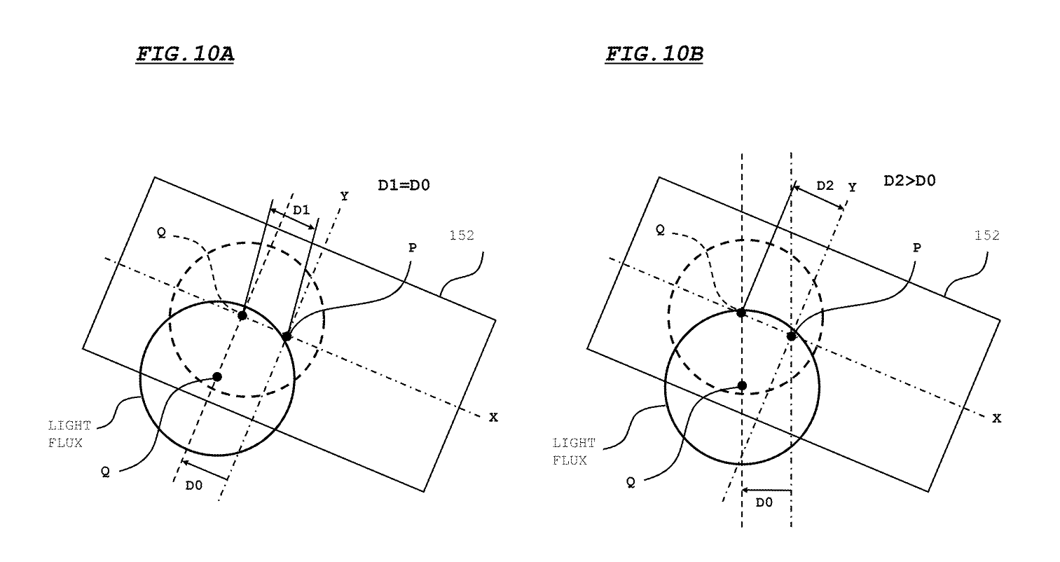

FIGS. 10A and 10B are diagrams showing movements of light flux on the incidence plane of the light tunnel 152 at adjustment of the optical axis of the light source lamp 300 in the case where the center Q of the light flux is displaced in a direction that cannot be adjusted. FIG. 10A shows movement of the light flux in this embodiment. FIG. 10B shows movement of the light flux in a comparative example in which the first holder 401 is shifted in a direction vertical to the bottom surface of the main body cabinet 1. FIGS. 10A and 10B each show by a solid line the light flux before the adjustment of the optical axis, and show by a broken line the light flux after the adjustment of the optical axis.

Both of this embodiment and the comparative example are based on the assumption that the center Q of the light flux is displaced by a displacement amount D0 in a direction that cannot be adjusted. As shown in FIG. 10A, in this embodiment, when the optical axis is adjusted such that the center Q falls at the center of the incidence plane along the shorter side (on the line of the central axis X), a displacement amount D1 of the center Q of the light flux from the center P of the incidence plane of the light tunnel 152 becomes equal to the displacement amount D0. That is, in this embodiment, the displacement amount D1 of the center Q of the light flux after the adjustment of the optical axis does not become larger than the displacement amount D0 in the direction that cannot be adjusted.

In contrast, in the comparative example as shown in FIG. 10B, if the optical axis is adjusted such that the center Q of the light flux falls at the center of the incidence plane along the shorter side (on the line of the central axis X), a displacement amount D2 of the center Q of the light flux from the center P of the incidence plane of the light tunnel 152 becomes larger than the displacement amount D0.

In this manner, this embodiment makes it possible to reduce the displacement of the center Q of the light flux from the center P of the incidence plane of the light tunnel 152 after the adjustment of the optical axis, as compared with the comparative example in which the first holder 401 is shifted in the direction vertical to the bottom surface of the main body cabinet 1.

As described above, in this embodiment, the optical axis of the light source lamp 300 is adjusted by shifting the light source lamp 300 with respect to the light tunnel 152 with the incidence plane inclined with respect to the bottom surface of the main body cabinet 1, in the direction parallel to the shorter side of the inclined incidence plane. Accordingly, since the light source is shifted in a direction in which the incidence plane has a shorter side to make light flux prone to extend off the incidence plane, it is possible to prevent effectively that the light flux extends off the incidence plane, only by adjusting the optical axis in a uniaxial direction. Further, even if the center Q of the light flux is displaced in a direction that cannot be adjusted, it is possible to minimize displacement of the center Q of the light flux from the center P of the incidence plane after the adjustment of the optical axis.

In addition, in this embodiment, the light source lamp 300 is shifted by the first holder 401, the second holder 402, the axial portions 415 and the guide holes 424 provided on the holders 401 and 402, which can simplify an arrangement for optical axis adjustment.

Further, in this embodiment, the arm portion 416 extends outward from the top portion of the first holder 401. The arm portion 416 is formed so as to extend toward the lamp opening 1c. Accordingly, the operator can move the arm portion 416 to easily shift the first holder 401 and make optical axis adjustment. In addition, the lamp opening 1c and the lamp cover 5 covering the lamp opening 1c are provided above the arm portion 416. Accordingly, the operator can open the lamp cover 5 to easily make optical axis adjustment through the lamp opening 1c, without the need to remove the upper cabinet 3.

Although an embodiment of the present invention is as described above, the present invention is not limited to this embodiment. Besides, the embodiment of the present invention can be modified in various manners as appropriate within the scope of a technical idea recited in the claims.

For example, in this embodiment, the first holder 401 is provided with the axial portions 415 as guided portions in the present invention, and the second holder 402 is provided with the guide holes 424 as guiding portions in the present invention. Alternatively, in an opposite manner, the first holder 401 may be provided with the guide holes 424 and the second holder 402 may be provided with the axial portions 415.

In addition, the guided portions and the guiding portions in the present invention may not necessarily be the axial portions 415 and the guide holes 424, respectively, as far as the guiding portions can guide the guided portions in a direction in which the first holder 401 is shifted. For example, these portions may be configured in such a manner that the guided portions are formed as ribs extending in the shift direction, the guiding portions are formed as grooves narrow and long in the shift direction, and the ribs are guided by the grooves.

Further, in the foregoing embodiment, the light tunnel 152 is used to unify intensity distribution of light from the light source lamp 300. However, the present invention is not limited to this arrangement, but may use another rod-type integrator, for example, a glass rod integrator.

In addition, in the foregoing embodiment, optical axis adjustment is performed by fixing the light tunnel 152 and moving the light source lamp 300. However, the present invention is not limited to this arrangement, but may be configured in such a manner that the light source lamp 300 is fixed and the light tunnel 152 is moved. Accordingly, the light source lamp 300 is shifted relatively with respect to the incidence plane of the light tunnel 152. In this manner, if the light source lamp 300 is fixed and the light tunnel 152 is moved, an optical axis adjustment mechanism may be provided between the imager unit 15 and the holder 232 of the control circuit unit 23, for example, to thereby shift the lamp unit 14 in the direction parallel to the shorter side of the incidence plane of the light tunnel 152. In this case, the imager unit 15 including the light tunnel 152 is shifted.

As described above, in the present invention, either the light source or the integrator may be moved as far as the light source is shifted relatively with respect to the incidence plane of the integrator in the direction parallel to the shorter side of the incidence plane.

Further, although the DMD 154 is used as an imager constituting the imager unit 15 in the foregoing embodiment, a liquid crystal panel may be used instead.

Moreover, although the lamp unit 14 having the light source lamp 300 is used in the foregoing embodiment, any light source other than the lamp light source, for example, a laser light source or an LED light source may be used instead.

Besides, the embodiment of the present invention can be modified in various manners as appropriate within the scope of a technical idea recited in the claims.

What is claimed is:

1. A projection display device, comprising:
a light source;
a rod-type integrator which unifies light emitted from the light source in intensity distribution;
an imager which modulates the light emitted from the integrator; and
an optical axis adjuster for adjusting an optical axis of the light source with respect to an incidence plane of the integrator, wherein
the integrator has the incidence plane formed in the shape of a rectangle and inclines around an optical axis of the integrator with respect to an installation surface of a main body cabinet in which the light source is disposed, and
the optical axis adjuster shifts the light source relatively with respect to the incidence plane in a direction parallel to a shorter side of the incidence plane.

2. The projection display device according to claim 1, wherein
the optical axis adjuster includes a first holder holding the light source and a second holder holding the first holder, and
one of the first holder and the second holder is provided with a guided portion, and the other of the same is provided with a guiding portion which guides the guided portion in a direction parallel to the shorter side of the incidence plane.

3. The projection display device according to claim 2, wherein
the first holder has an operation portion to be operated in shifting the first holder so as to extend outward.

4. The projection display device according to claim 3, wherein
the main body cabinet is provided with an opening for exposing the light source to the outside and a cover for covering the opening, and
the operation portion extends toward the opening.
